(19) United States
(12) Patent Application Publication
(10) Pub. No.: US 2013/0177895 A1
(43) Pub. Date: Jul. 11, 2013

(54) METHODS AND APPARATUS FOR DYNAMIC TRAINING

(71) Applicant: Sean C. Kearns, Fountain Hills, AZ (US)

(72) Inventor: Sean C. Kearns, Fountain Hills, AZ (US)

(73) Assignee: Proving Ground LLC

(21) Appl. No.: 13/345,501

(22) Filed: Jan. 6, 2012

(51) Int. Cl. G09B 7/00

(52) U.S. Cl. 434/362

(57) ABSTRACT

Methods and apparatus for dynamic training according to various aspects of the present invention may comprise administering training content according to a user in conjunction with a configuration option. The configuration option may be substantially optimized to increase a user's training participation and/or increase a user's retention of the training content.

### BACKGROUND OF THE INVENTION

Classroom training, one-on-one coaching, seminars, best-practices discussions, and traditional studying have been the primary methods of providing education and training. Each of these traditional methods, although somewhat effective, fails to provide an efficient way to achieve the context-specific repetition and application necessary for developing long-term memories. A more effective method of facilitating learning is to provide a student with a directed multiple-choice testing format that provides for a case study analysis and provides the student with answer feedback. The directed multiple-choice format may better facilitate long term memory development and habit formation by allowing for more repetition.

To get the most training benefit from case studies, it is important that the appropriate case studies be used for each individual. The case studies need to have the right difficulty level, teach skills that are relevant, and cover topics that are important to the individual. The case studies also should be presented in way that corresponds to the individual's learning style and the format should encourage a worker to continue participating while increasing content retention.

A typical case study training format is comparable to a multiple choice testing format. Generally, a case study is displayed and a user is prompted to select one or more answers from multiple candidate answers, as the best solution to the problem disclosed in the case study. After the user has selected an answer, the correct answer may be displayed along with an explanation as to why it is the correct answer. The user then indicates readiness to advance to the next problem.

### SUMMARY OF THE INVENTION

Methods and apparatus for dynamic training according to various aspects of the present invention may comprise administering training content according to a user in conjunction with a configuration option. The configuration option may be substantially optimized to increase a user's training participation and/or increase a user's retention of the training content.

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a training system;

FIG. 2 is a block diagram of a client system;

FIG. 3A is a block diagram representing a client system running the training system;

FIG. 3B is a block diagram representing a client system running a training system that utilizes a content database located a remote server;

FIG. 3C is a block diagram representing a client system running an application that accesses the training system that utilizes a content database located a remote server;

FIG. 4 representatively illustrates the visual layout of testing system;

FIG. 5A representatively illustrates the visual layout of the testing system as modified by the icons filter;

FIG. 5B representatively illustrates the visual layout of the testing system as modified by an alternative embodiment the icons filter;

FIG. 6 representatively illustrates the operation of the testing system with the bullsh*t filter enabled; and

FIG. 7 representatively illustrates the operation of the testing system with the interlude filter enabled.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ systems, technologies, algorithms, designs, and the like, which may carry out a variety of functions. In addition, the present invention may be practiced in conjunction with any number of hardware and software applications and environments, and the system described is merely one exemplary application for the invention. The present invention may also involve multiple programs, functions, computers and/or servers. While the exemplary embodiments are described in conjunction with conventional computers, the various elements and processes may be implemented in hardware, software, or a combination of hardware, software, and other systems. Further, the present invention may employ any number of conventional techniques for administering a test.

For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Methods and apparatus for dynamic training according to various aspects of the present invention may operate in conjunction with any suitable interactive system and/or process. Various representative implementations of the present invention may be applied to any system for optimizing, displaying, and coordinating training material. Certain representative implementations may comprise, for example, methods or systems for displaying training material on a display.

A training system according to various aspects of the present invention may provide a user with relevant training material to help the user learn information, skills, concepts, job training, or other relevant material. In one embodiment, the training system may comprise multiple sections to facilitate learning and certify that the user has learned the material.

An administrator, such as an employer or a teacher, may elect to require a training course. The administrator may select the various training materials for that course. For example, the administrator may require a training course on a new sales technique. The training materials may comprise a general description of the sales technique, how and when to implement the sales technique, and case studies that test a user's mastery of the new technique. The administrator may select the various parameters of how the training will take place. For example, the administrator may require the course to be completed in a certain amount of time and/or the minimum score the user must achieve to pass the course. The training materials may then be divided into various sections and questions, case studies, answers, and explanations may be created.

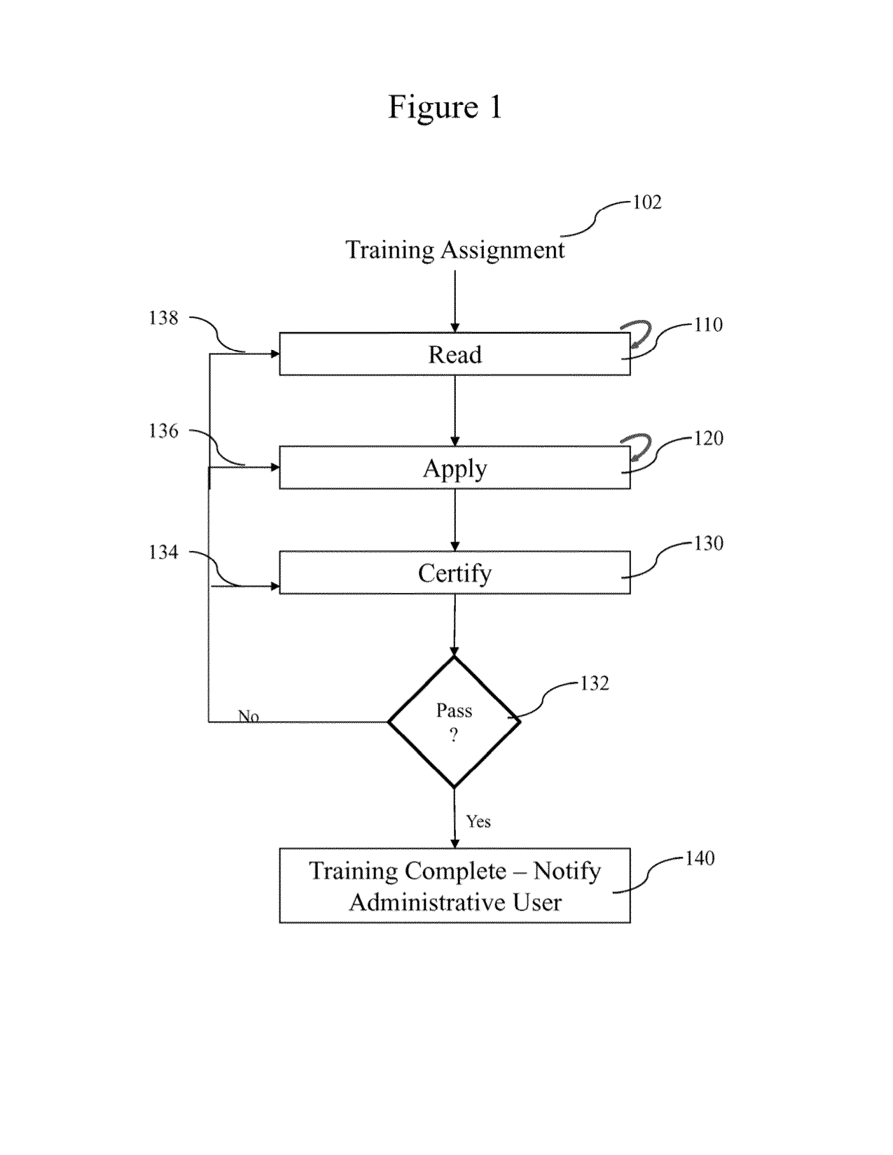

For example, referring to FIG. 1, the training system 100 may include a read section 110, an apply section 120, and a certify section 130. The training materials for each section may be selected and/or created by the administrator. After the user has been assigned a training assignment 102, the user may start the training by entering and completing the read section 110. Upon the completion of the read section 110, the user may elect whether to continue reviewing the material in the read section 110 or continue onto the apply section 120. After completing the apply section 120, the user may elect whether to continue working in the apply section 120 or may move on to the certify section 130. If the user passes the certify section 130 (132), then the training is deemed complete and the administrator may be notified 140. If the user does not pass the certify section 130 (132), the user may attempt the certify section 130 again (134), or may return to one of the previous sections (136, 138).

In one embodiment, the training system 100 may be remotely accessed by the administrator. The administrator may view the user's progress through the various sections as well as the user's performance. In one embodiment, the administrator may also adjust parameters, such as adjusting deadlines and required scores for passing certification 130. The administrator may also adjust the training material by adding new material, deleting material, and/or editing material.

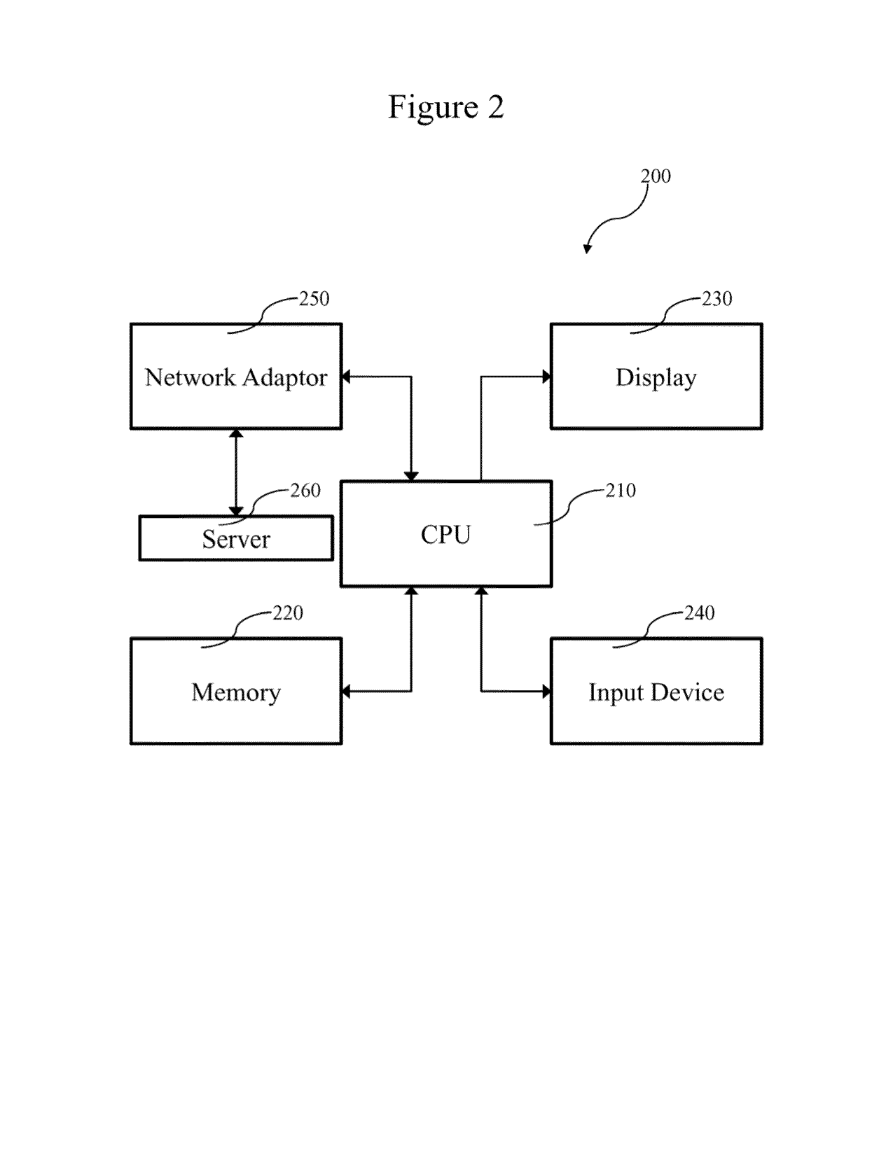

The training system 100 may be configured to be accessed by, or run on, a client system. The client system may comprise any suitable client system such as a personal computer, a smart-phone, a tablet computer, a television, or an e-reader. The client system may be configured to access and display the training system 100, as well as accept input from a user. For example, with reference to FIG. 2, the client system 200 may comprise a CPU 210, a memory 220, a display 230, and an input device 240. The training system 100 may be stored in memory 220, while the CPU 210 may be configured to access and write to the memory 220. The CPU 210 may also be configured to provide the display 230 with content from the training system 100 and to receive input from the input device 240. In one embodiment, the input device 240 may be integrated into the display 230, such as in a touch screen display.

In another embodiment, the client system 200 may further comprise a network adaptor 250 that allows the CPU 210 to connect to a remote server 260. The server 260 may comprise a conventional computer server comprising a CPU 210, memory 220, and network adaptor 250. Thus, the training material may be stored on the server 260 in a user accessible memory 220 regardless of the memory being located on the client system 200 or on the server 260.

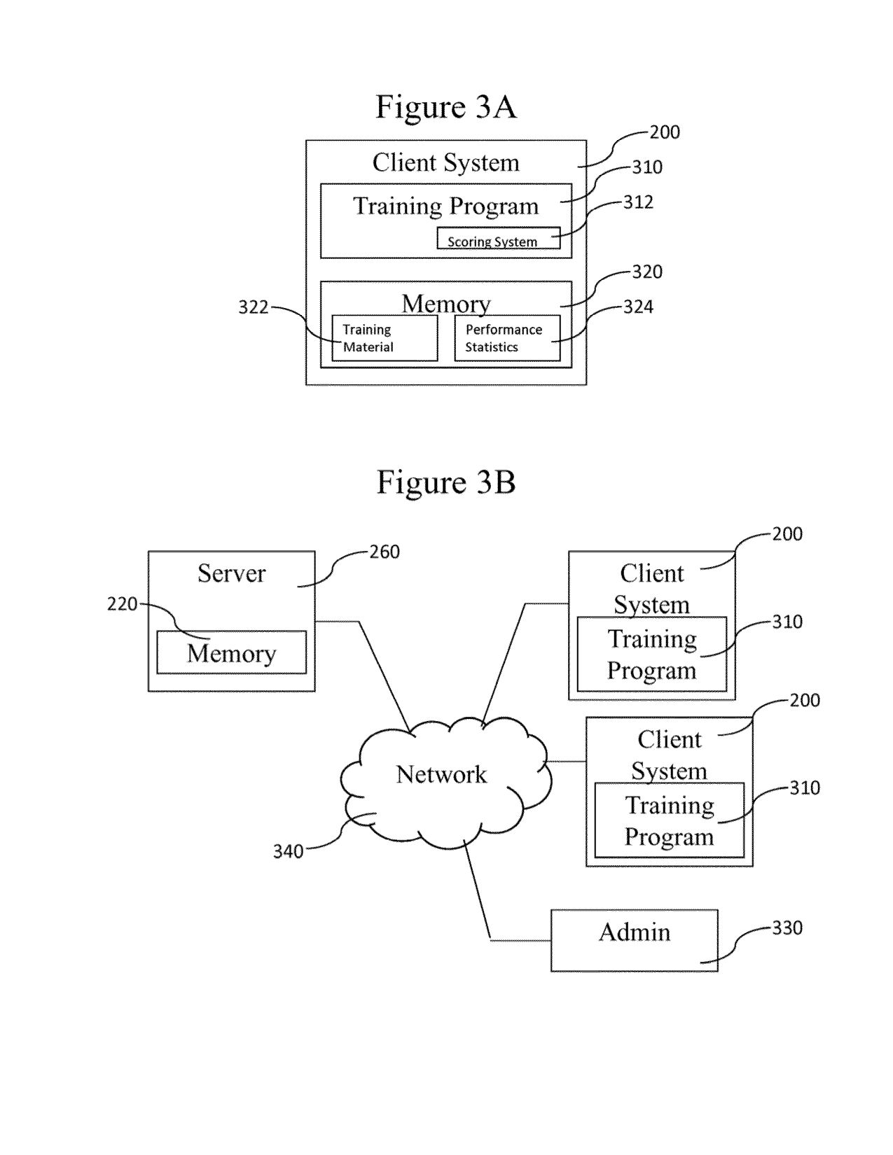

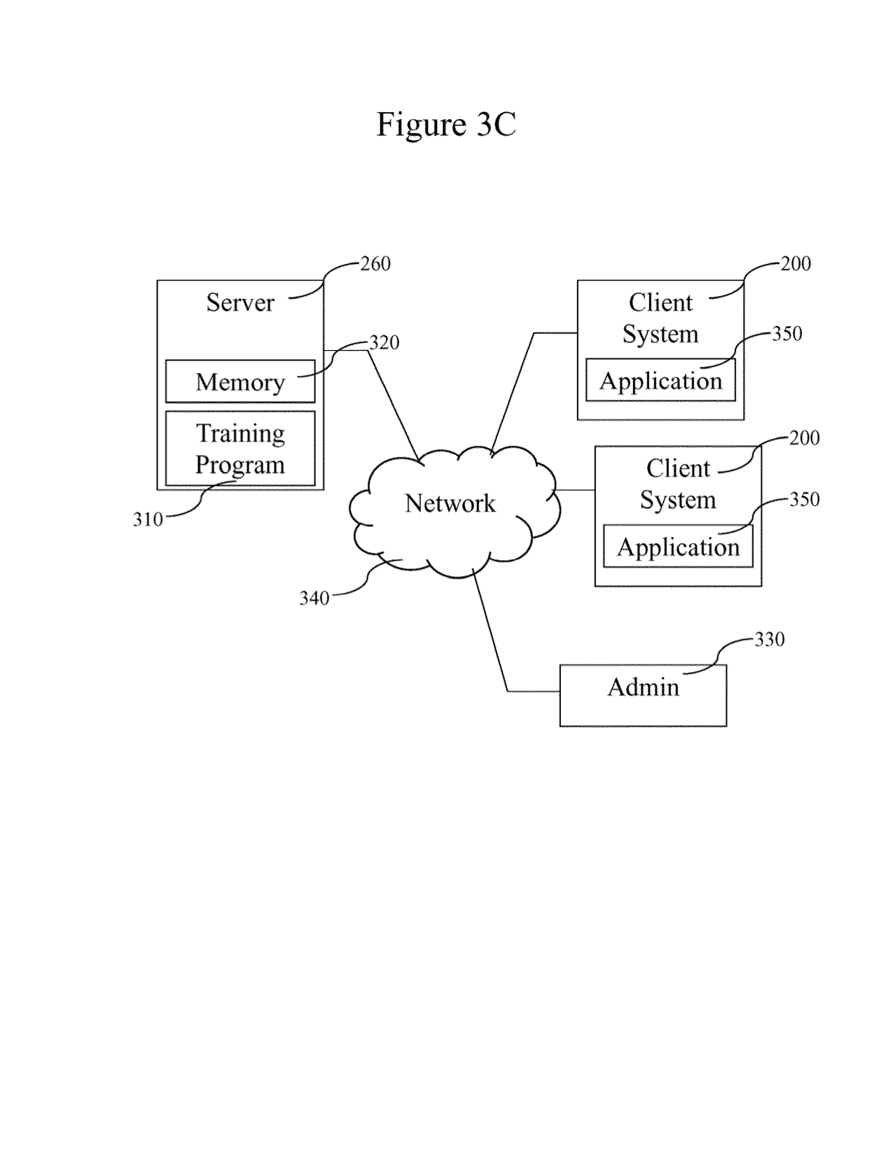

The training system 100 may be divided into separate operating components. For example, referring to FIG. 3A, in one embodiment, the client system 200 may run a training program 310 and operate a memory 320 that contains the training material 322. In one embodiment, the memory 320 may comprise a database. Referring now to FIG. 3B, in another embodiment, the memory 320 may be located on the server 260. The server 260 may be accessible via a network 340. The server may be located on a local intranet or on the Internet. The training program 310 and the memory 320 may be configured to work seamlessly over the network 340. The network 340 may be a direct network connection, a local intranet connection, or an internet connection. An administrator 330 may also be connected to the network 340 and able to connect to the client systems 200 and server 260.

The training system 100 may also be configured to keep track of the user's progression through the training system 100 and user performance statistics 324 using a scoring system 312. The scoring system 312 may operate within the training system 310 and modify the performance statistics 324 as the user progresses through the training material 322. The performance statistics 324 may be stored in the memory 320. The training system 310 may update the scoring system 324 based on whether a selected answer was correct or incorrect. The performance statistics 324 may comprise the number of questions the user has answered, the number of questions correctly answered, the amount of time spent using the training system 100, the amount of time spent in each section, the number of times the certify section 130 was attempted, and any other relevant statistics. The performance statistics 324 and the user's progression through the training material 322 may be accessed by the user and/or by an administrator.

In one embodiment, the training system 100 may be configured to run on the server 260 and be accessed by the client system 200 via an application 350. In one embodiment, the application 350 may comprise an internet browser such as Internet Explorer, Safari, Firefox, Opera, or Chrome etc. In another embodiment, the application 350 may comprise a client system specific application. For example, the application may comprise a native OS application designed to run natively on an operating system such as iOS, Android, Windows, Windows Phone, Symbian OS, Blackberry OS, webOS, Mac OS, Linux, Unix or any other operating system. The application 350 may also be a cross platform application, such as a Java or Adobe Flash application. The application 350 may display the various elements of the training system 100 and accept user inputs, while training system 100 is operating remotely on the server 260. Thus, the application 350 server 260 may receive the user inputs and supply the browser with the corresponding information to be displayed.

User input for selecting the various answer options or accessing a program menu may be allowed in any way facilitated by the device that is being used. For example, on a personal computer, the training program 210 may be designed to accept both keyboard and mouse input. In another example, on a touchscreen device such as a tablet computer or smartphone, the training program may be configured to receive a touchscreen input.

The training system 100 may be installed on one or more client systems. For example, if the training system 100 operates solely on the client system 200, then the training system 100 may be installed in a manner similar to a conventional computer program or hardcoded into the machine. If the training system 100 is implemented across multiple computers, such as with the client system 200 and the server 260, then relevant elements of the training system 100 may be installed on the server 260. Additional elements may be implemented by the client system 200, or the client system 200 may operate as merely a terminal, for example if the client system 200 is utilizing an internet browser to interface with the training system 100 that is operating on the server 260. If the application 350 comprises a native OS application, then the native OS application may be installed on the client system 200.

The user may begin training by starting the read section 110. The read section 110 may comprise bulk material for consumption by the user. The training system 100 may require that the read section may be presented to the user before the apply 120 and certify 130 sections can be accessed. The bulk material may comprise material designed to convey the training material 322 to the user and may include rules, guidelines, essays, reports, charts graphs, diagrams, or any other means of conveying the training material 322. The read section 110 may also be available at any time for the user to use as reference material.

For example, the read section 110 may include information relating to a new sales protocol. In this example, the read section 110 may comprise an outline of the sales protocol itself, instructions on situations where the sales protocol should be used, diagrams conveying the effectiveness of the sales protocol in those situations, and information relating to how to identify a situation where the sales protocol should be used. The read section 110 could also provide a user with a lecture with the information, or could also include video of the sales protocol being used. In other words, the read section 110 may provide the user with the training material 322, but not actively require the user to apply the material.

The apply section 120 may simulate situations that require the application of the training material 322. The apply section 120 may be configured as a case study based teaching system comprising testing content and a scoring system. The testing content may comprise multiple case studies, questions based on the cases studies, potential answers to the questions, and explanations of the best answers for each question. The scoring system may track any relevant performance statistics 324, such as the user's correct and incorrect responses, progression through the testing content, and may also determine and track a user score.

In one embodiment, the apply section 120 may present the user with a case study to evaluate. In addition to the case study, the apply section 120 may also present the user with a question prompt and potential answers. Each of the potential answers may be selectable. The apply section 120 may also present the user with an answer confirmation button to confirm that a selected answer is the user's final answer.

The user may select a potential answer from the list of potential answers and then select the answer confirmation button to confirm the selection and move forward. The apply section 120 may then evaluate the selection to determine if the best or correct answer was selected. The apply section 120 may then notify the user whether the correct answer was selected and offer an explanation as to why the answer is correct. The apply section may also provide the user with an explanation as to why an incorrect answer is either incorrect or not the best answer. The apply section 120 may also present the user with an advance button that the user may use to indicate that they are ready to move on to the next problem.

As each case study is evaluated and answered, the training system 100 may keep track of performance statistics 324. The performance statistics 324 may comprise any relevant performance statistics 324 including, the number of questions attempted, the number of questions answered correctly, the amount of time spent on each question, and/or any other relevant performance information.

The certify section 130 may test the user's mastery of the training material 322. In one embodiment, the certify section 130 may comprise a case study based multiple choice test. The case study based multiple choice test may be formatted with a case study, a question prompt, and potential answers, similar to the case study based teaching system of the apply section 120, but may not provide the user with answer explanations or immediate feedback. The multiple choice test may be of sufficient length to test the mastery of the training material 322. If the user answers enough of the questions correctly, the user may be certified for the training material 322.

The testing content may comprise any suitable content for teaching the training material 322 and may be configured in any suitable format. For example, the testing content may comprise the case study, the question prompt, potential answers, and answer explanations. The case study may provide a series of facts and or situations that are directed towards simulating situations and complex problems that the user will potentially encounter in the future, causing the user to simulate the decision making required in those situations. The question prompt may then ask a question or ask for a best course of action for the given situation or facts. The potential answers may be displayed and may include a series of possible courses of action or responses. Depending on the answer selected, an answer explanation may be displayed and a score may be determined and recorded to the performance statistics 324. The user may then move on to the next case study.

The testing content may be supplied by any suitable source. For example, the testing content may be generated by a third party from training material 322 supplied by a user, administrator, and/or a by the third party. In another embodiment, the testing content may be modified by the administrator.

A case study may comprise fact patterns, statements, quotes, conversations, events, decisions, projects, policies, and/or rules that may be analyzed by the user to determine a correct response or course of action. The case study may offer enough information to perform an in-depth examination of a single event or case. The case study may comprise information that is relevant to the training material 322 and may include field of study related situations. Thus, the case studies may be configured to provide the user with repeated exposure to relevant situations for the user to learn the training material 322.

The question prompt may be any relevant question with regards to the case study. In one embodiment, the question prompt may be configured to simulate a real world decision making process. For example, the question prompt may ask a user for the most appropriate response to a query from a customer, the question prompt may ask the user to pick an option that best describes the situation, or the question prompt may ask the user to pick a best course of action.

The potential answers may comprise a plurality of multiple choice answers that may or may not be relevant to the question prompt and/or fact pattern. The potential answers may be located in any suitable location relative to the question prompt. The potential answers should each be user selectable and de-selectable.

The confirmation button may be configured to allow the user to confirm that the selected answer is the user's answer and that the user is ready to move on. Once the confirmation button is selected, the user's answer selection is graded and scored and the feedback may be displayed.

The testing content may comprise answer explanations for each potential answer and may be used to convey the training material 322. The user may select an answer to a proposed question regarding a case study and the apply section 120 will provide the user feedback regarding whether the selected answer was correct or incorrect and why an answer is a best answer.

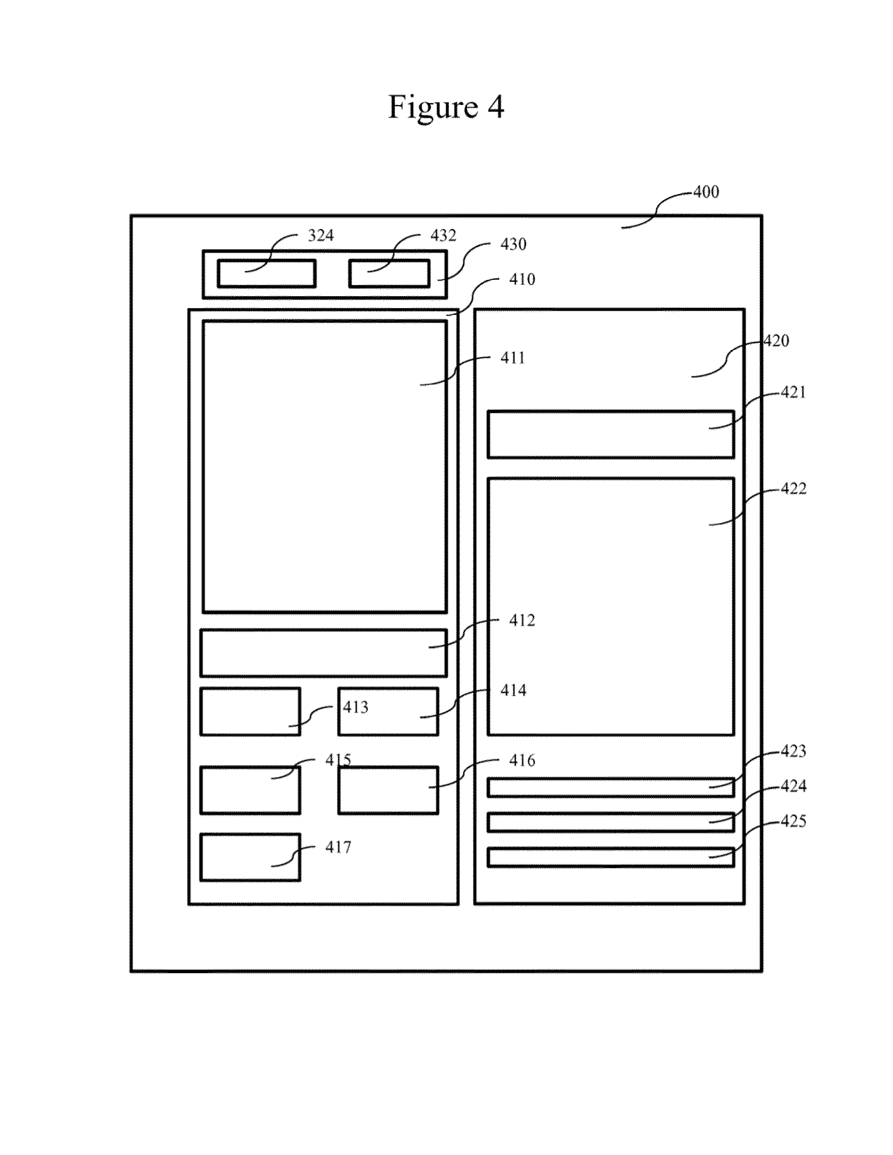

Referring to FIG. 4, a testing window 400 may run on a client system 200 and be configured to display a case study window 410, an explanation window 420, and a menu 430. The case study window 410 may be configured to display a relevant case study 411, a question 412 regarding the case study 411, potential answers 413, 414, 415, 416, and a confirmation button 417. Once one of potential answers 413, 414, 415, 416 has been selected, the confirmation button 417 may be selected, and the explanation window 420 may be activated to reveal an answer indicator 421 and an explanation 422. In one embodiment, the explanation window 120 may also include alternative explanations 423, 424, 425 that may be selected to provide reasoning as to why each of the incorrect multiple choice answers are not the best answer. The menu 430 may be configured as a drop-down menu.

The case study window 410 may be configured to display the case study 411, the question 412, the multiple choice answers 413, 414, 415, 416, and the confirmation button 417. The case study window 410 may be arranged in any suitable way to facilitate displaying the case study 411 and the multiple choice answers 413, 414, 415, 416. For example, the case study window 410 may be arranged with the question 412 displayed at the top of the case study window 410, the multiple choice answers 413, 414, 415, 416 in the middle of the case study window 410, and the case study 411 at the bottom of the case study window 410. The case study window 410 may be arranged differently for different case studies 411.

The explanation window 420 may be configured to appear after the user has selected one of the multiple choice answers 413, 414, 415, 416 and has confirmed that selection using the confirmation button 417. The explanation window 420 may display whether the user selected the correct answer using the answer indicator 421. The explanation window 420 may also include an explanation 422 describing the correct answer for the case study. In one embodiment, the explanation window 420 may include alternative explanations 423, 424, 425 that may be selected. The alternative explanation 423, 424, 425 may explain why the corresponding incorrect answers were incorrect.

The drop down menu 430 may be positioned at the top of the testing window 100. The drop down menu 430 may be configured to display performance statistics 324 and a filter menu 432.

The performance statistics 324 may be broken down into scoring information for various types of testing content. The performance statistics 324 may be based on any relevant scoring factors for the given testing content. For example, the performance statistics 324 may include raw scores, time spent, percentage of correct answers, percentage of questions answered, time remaining, or any other relevant scoring information. The scoring information may be broken down between various subjects, topics, courses, or any other relevant grouping. The scoring factors may include correct answers, time spent on a case study, or any other scoring factor that is suitable for the testing content.

The filter menu 434 may be configured to offer one or more filters, which may operate as configuration options to modify the presentation of the testing content. The filter menu 434 may present selectable options for the activation and deactivation of one or more filters/configuration options. The filters may implement any appropriate variations for presenting the testing content, for example to enhance learning by the user. For example, the filters may increase or decrease the difficulty of the test, such as by modifying the presentation of the testing content or the testing content itself. Alternatively, the filters may modify the pace at which the test is taken by the user, the feedback provided to the user, or other appropriate modification of the test experience and process.

The filter may be activated or deactivated in any suitable manner for the device that the training system is operating on, and may be configured to be controlled by the administrator, user, and or other relevant personnel. In one embodiment, the filter menu 434 may be enabled or disabled solely by an administrator. In another embodiment, the administrator may elect which filters are available for the user to enable or disable, or the user may be permitted to adjust the filters without input from the administrator. When a filter is activated or deactivated, the training system 100 may automatically adjust the presentation of the test material accordingly.

In one embodiment, the apply section 120 may allow a filter to be activated or deactivated. The filter may encourage the user to continue participating in the apply section 120. The filter may also or alternatively improve the user's memory retention of the training material 322 and/or decrease learning time. For example, in one embodiment, user participation and content retention may be increased, while learning time may be decreased by creating new challenges for the user, changing the presentation and scoring rules of the apply section 120, adding new and more interesting content, and by adding content that engages the user's various senses. In one embodiment, the filter may be configured to adjust the way the testing content is displayed, introduce new content in addition to the training material 322, and/or adjust scoring rules. For example, the filters may include a timer filter, an icon filter, a cover up filter, a layout filter, a sound filter, a bullsh*t filter, and/or an interlude filter.

In one embodiment, the filter may comprise a tinier filter. The timer filter may give a user a time limit for answering each question and thus increase test or simulation difficulty. By increasing the difficulty, training material 322 retention may be increased and/or the training system 100 may provide a more realistic simulation of an actual situation. In one embodiment, the tinier filter may cause a countdown clock to be activated, for example at the beginning of each case study or other section of the simulation. The countdown clock may start at a predetermined time and count down to zero. The countdown clock may be stopped when the user confirms an answer selection. The timer filter may also modify the scoring system 312 when activated so that an answer is only scored as correct if it was selected before the countdown clock reached zero, and an answer may be deemed incorrect if the correct answer was not selected before the countdown clock reached zero or if an incorrect answer was selected.

The countdown clock may be the same for every case study or it may vary, for example according to the length or difficulty of the case study. In one embodiment, the countdown clock is suitably set for each case study based on any appropriate factors such as case study length, question length, and/or answer length. In another embodiment, the countdown clock may have multiple speed settings. For example, the countdown clock may have a slow, a medium, and a fast count-down setting. In one embodiment, the speed setting may be selected by the user and/or the administrative user.

The filter may also comprise a cover-up filter. The cover-up filter may be configured so that the user cannot view the list of potential answers to look for clues for the correct answer. The cover-up filter may modify the presentation of the testing content by preventing the list of potential answers from being displayed until after a trigger has been activated. The trigger may be any suitable trigger and may be configured to encourage the user to read the complete case study and to formulate an answer to the question before seeing the potential answers. By forcing the user to formulate an answer before seeing the potential answers, the difficulty of the question is increased. In one embodiment, the trigger may comprise a “show answers” button that may be selected by the user. In another embodiment, the trigger may be a timer. In yet another embodiment, the trigger may comprise a show-answers button that is only selectable after the expiration of a timer.

The filter may also comprise an icon filter. The icon filter may display various portions of the content with representative icons. Each icon may be associated with a specific portion of the training information. For example, feedback may be displayed in conjunction with icons that represent the feedback. Thus, as the user learns the association between the icon and the concept associated with the icon, the user no longer needs to read the entire feedback.

The icon may comprise any suitable graphic for displaying the concept. For example, the icon may comprise a picture, a sound, an animation, or a video. The user may view the icons and grasp the explanation without reading the full explanation. The icon filter may help increase the speed at which a user understands an explanation, as the user can quickly view and understand a series of icons instead of reading a written explanation. By increasing speed, the user may review more case studies in a given period of time. By increasing the number of case studies analyzed by the user, content retention and/or test efficiency may be increased.

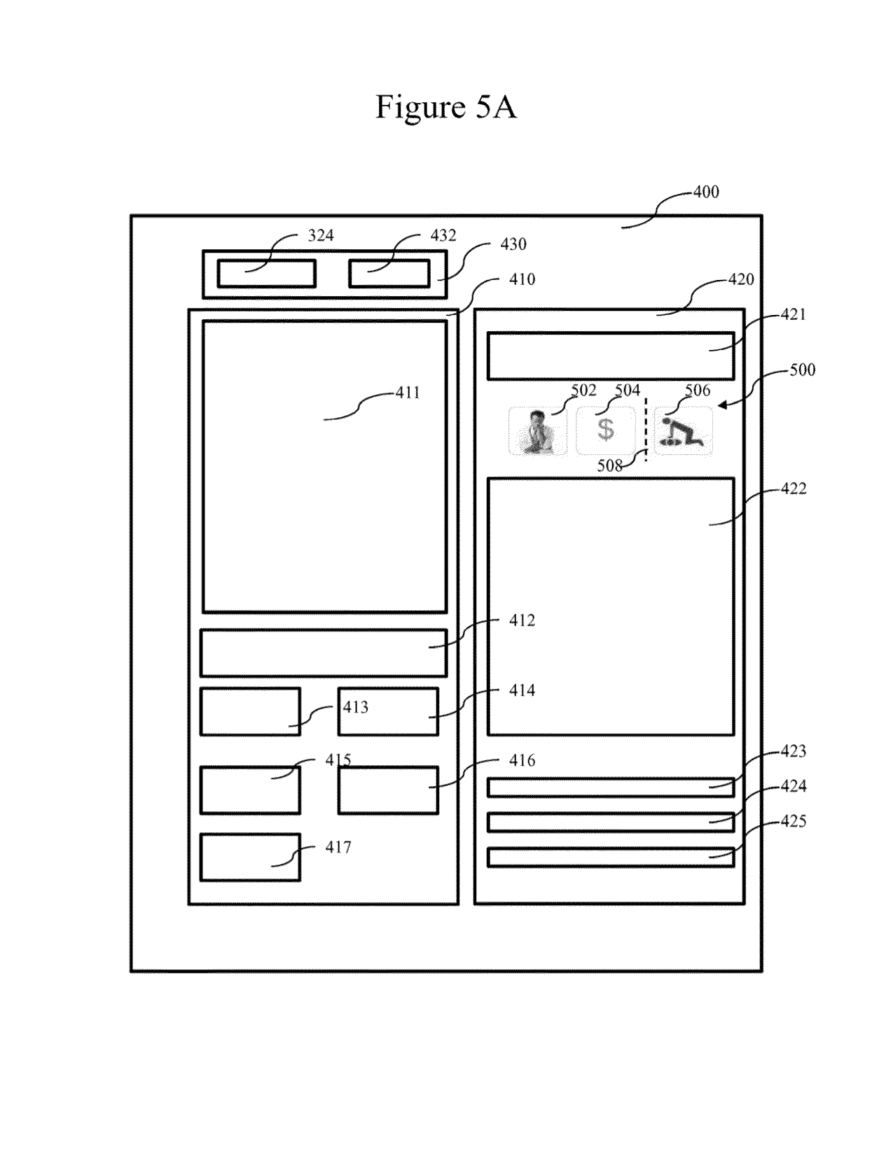

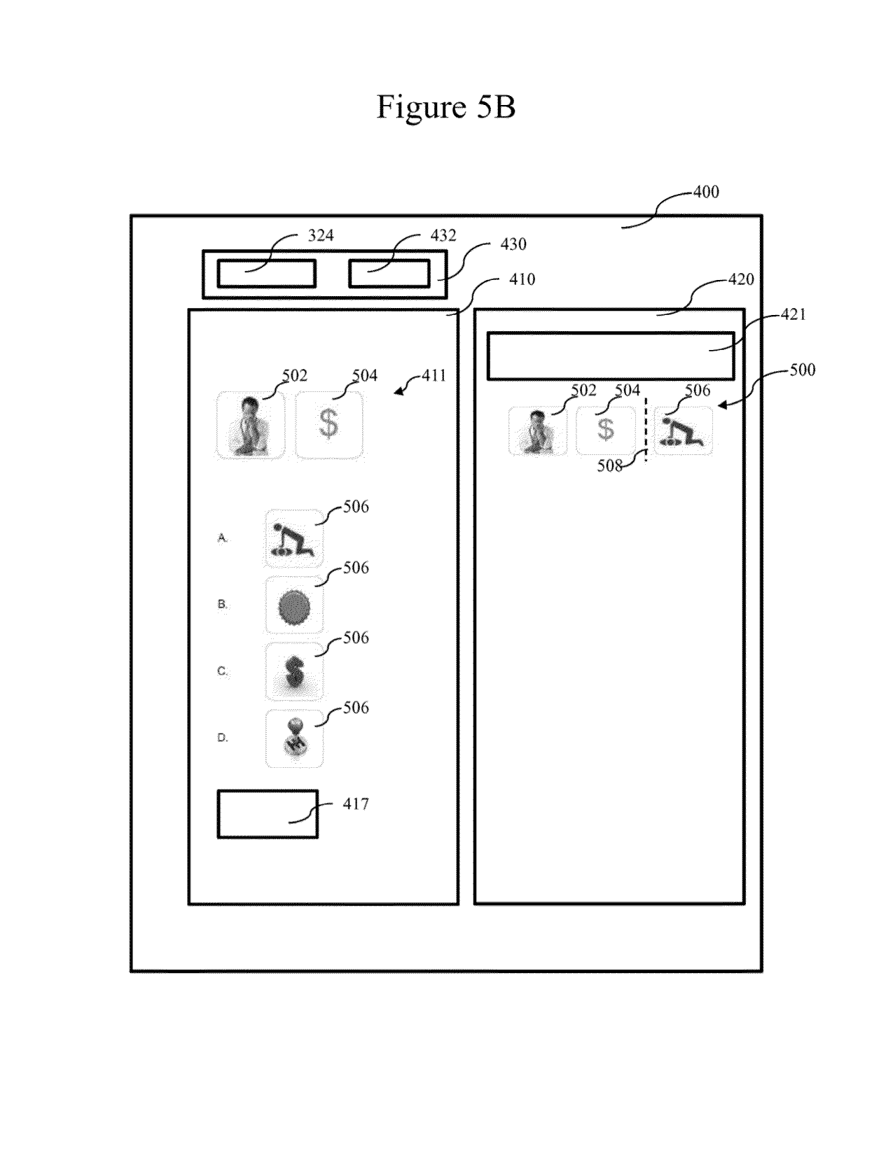

Referring to FIG. 5A, in one embodiment, multiple icons 500 may be utilized. The icons 500 may be placed in the explanation window 420 and may be hidden until the answer indicator 421 and the explanation 422 are shown. The icons 500 may be utilized to convey both the concept and a skill that is required to be applied to answer the question 412 correctly. For example, the concept icons 502, 504 may identify concepts in the case study 411, while skill icon 506 may identify skills that should be applied to the concepts in case study 411 to arrive at the correct answer. The various icons may be presented in any suitable manner. In one embodiment, the concept icons 502, 504 may be separated from the skill icon 506 by a dividing line 508. For example, any icons to the left of the dividing line 508 may comprise concept icons 502, 504, while any icons to the right of the dividing line 508 may comprise skill icons 506. Likewise, the skill icons 506 could be positioned to the left of the dividing line 508, while concept icons 502 504 could be positioned to the right of the dividing line 508.

In one embodiment, the concept icon 502 may depict a person with a negative reaction. Thus, the concept icon 502 may be associated with a negative reaction from a person. In another embodiment, the concept icon 504 may depict a conventional dollar sign (S) and be associated with cost being a factor in the case study 411. Thus, the user may be able to discern, that in the case study 411 being presented there has been a negative reaction associated with cost. In this embodiment, the skill icon 506 may be associated with a response that may be associated with performing CPR. Thus, the appropriate response to the case study 411 is the identification of the negative reaction associated with cost and then performing CPR. The icons 500 may comprise any suitable graphics for displaying the concepts and skills.

In one embodiment, the icons may be user selectable. For example, if the concept icon 502 is selected by the user, the portion of the case study 411 that corresponds to the concept associated with the concept icon 502 may become highlighted. Similarly, if the concept icon 504 is selected by the user, the portion of the case study 411 that corresponds to the concept associated with the concept icon 504 may become highlighted. If the skill icon 506 is selected, the portion of the explanation that corresponds to the skill associated with the skill icon 506 may become highlighted.

In one embodiment, the icon filter may have multiple icon display options. For example, the icon filter may allow the user to select an option to display only the icons 500 in lieu of the explanation 422. Thus, after a user selects an answer 413, 414, 415, 416 and selects the confirmation button 417, the answer indicator 421 and the icons 500 may be displayed in the explanation window 420.

Referring now to FIG. 5B, in another embodiment, the icon filter may be configured to allow the user to select an option to display the case study 411 as the concept icons 502, 504 in lieu of a written case study and the icons 500 in lieu of the explanation 422. In this embodiment, the potential answers may comprise various skill icons 506. Thus, the user is able to rely solely on icons for conducting an analysis.

The fitter may also comprise a layout filter. The layout filter may allow the user to change the positioning of the various windows or other aspects of the graphical interface. By allowing the user to change the layout, the user can customize the display format to fit the user's personal preferences or to be better suited to the client system.

The filter may comprise a sounds filter. The sounds filter may play a sound depending on a correct or incorrect answer selection. For example, in one embodiment, the sounds filter may play a pleasant sound when a correct answer is selected and an unpleasant sound when an incorrect answer is selected. By playing pleasant and unpleasant sounds, the user may be encouraged to better associate case studies with correct responses while not associating case studies with incorrect responses, thus improving content retention. In one embodiment, the sounds played may be selected by the user.

The filter may further comprise a bullsh*t filter. The bullsh*t filter may add an additional recognition step, for example after a question is answered and the explanation is displayed. In one embodiment, the bullsh*t filter may add a bullsh*t button in the explanation window and randomly provide an incorrect explanation when the user selects the correct answer. Thus, after a user selects the correct answer, the user explanation tells the user that the selected answer was incorrect and gives the user an explanation regarding one of the incorrect answers. The user is tasked to recognize that the explanation is incorrect and to indicate that the user's answer was the real correct answer via the bullsh*t button. If an incorrect explanation has been displayed, and either the bullsh*t button or the advance button has been pressed, a correct explanation then may be displayed. If a correct explanation was displayed and the user incorrectly presses the bullsh*t button, then the user may be notified that the explanation that was displayed was correct.

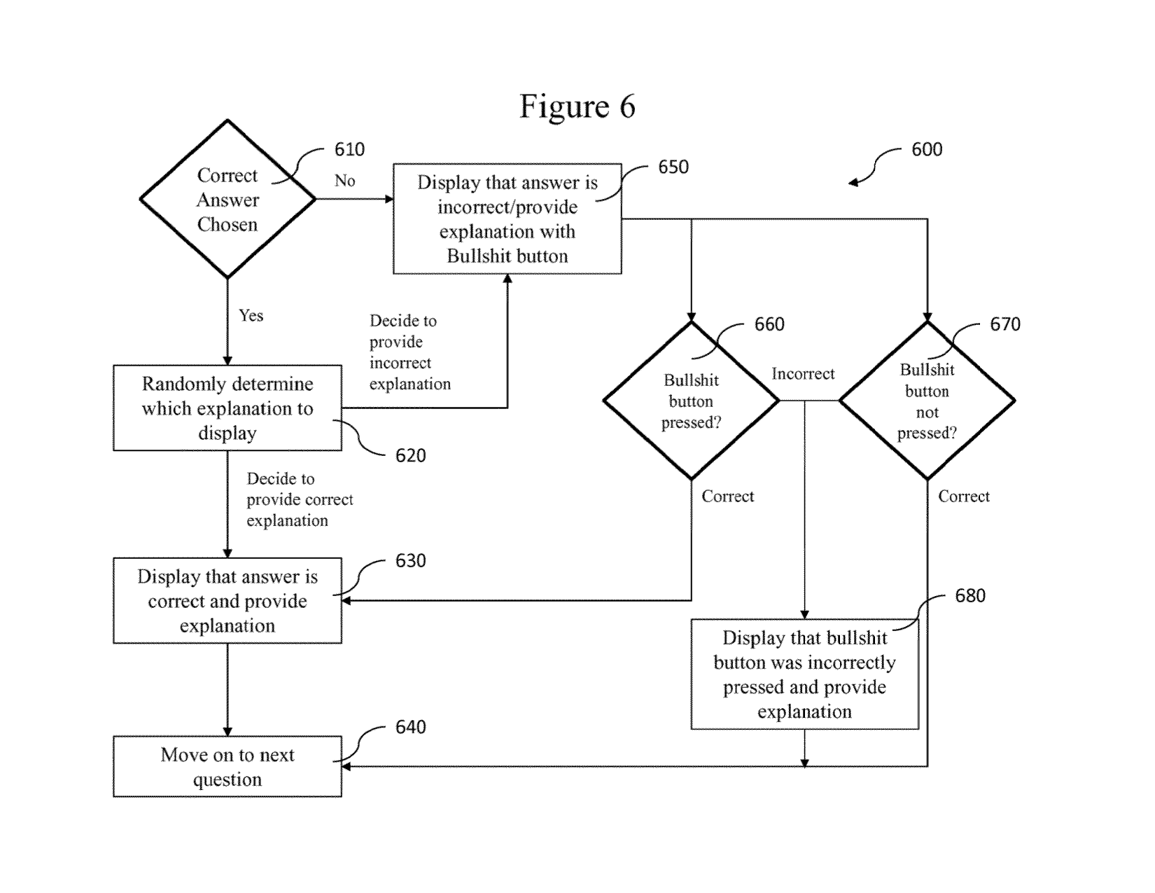

Referring to FIG. 6, once a user's answer has been submitted, the answer is evaluated to see if the correct answer was chosen (610). If the correct answer was chosen, then the bullsh*t filter 600 may determine if it should provide a correct or incorrect explanation (620). The bullsh*t filter 600 may randomly determine to provide an incorrect explanation, or it may determine to provide an incorrect explanation according to other appropriate criteria. If the bullsh*t filter 600 selects to provide the correct explanation, the testing system 100 operates normally, the user is notified that the correct answer was chosen, and an answer explanation is displayed (630). The user may then move on to the next question (640).

If the bullsh*t filter 600 determines to provide an incorrect explanation even though the correct answer was selected or if an incorrect answer was selected, the testing system 100 may notify the user that an incorrect answer was selected, provide an explanation regarding the correct answer, and activate the display of a bullsh*t button (650). If the user feels that the answer entered was correct and the explanation was incorrect, the user may elect to select the bullsh*t button (660). If the user concedes that he answered incorrectly he may elect to not press the bullsh*t button (670) and move on to the next question (640). If the bullsh*t button is correctly pressed, the user may be notified that his answer is correct (630). If the bullsh*t button was incorrectly pressed, or not pressed when it should have been, the user may be notified that bullsh*t button was not correctly pressed and the bullsh*t filter 600 may provide the user with a correct explanation (680). The user may then move on to the next question (640).

In one embodiment, the scoring system 312 may be modified by the bullsh*t filter. For example, if a user incorrectly indicates that an explanation is incorrect, the user's score may be decreased. In a case where the user does not recognize that an explanation is incorrect after selecting a correct answer then the user's score may be decreased, or in another embodiment, the score may be held constant. If the user does answer correctly and then correctly recognize that the explanation is incorrect, then the user's score may be increased. If the user answers correctly and the bullsh*t filter 600 provides a correct response, the user's score may be increased.

By altering this aspect of the training system, the overall difficulty of the apply section 120 may be increased. The additional challenge presented by the adding the bullsh*t filter may encourage content retention, while, the randomized nature of the bullsh*t filter may encourage continued participation.

The filter may also comprise an interlude filter. The interlude filter may be configured to randomly supply the user an interlude content comprising interesting content that may or may not be related to the testing content. For example, the interesting content may be user selectable and geared towards user preference. In one embodiment, when the interlude filter is turned off, the user would only see questions from the testing content, but when the interlude filter is turned on, the user would see mostly questions from the testing content, but occasionally the user would see questions from an unrelated course of their choice, like “How to Play BlackJack” or “Silly Knock-Knock Jokes.”

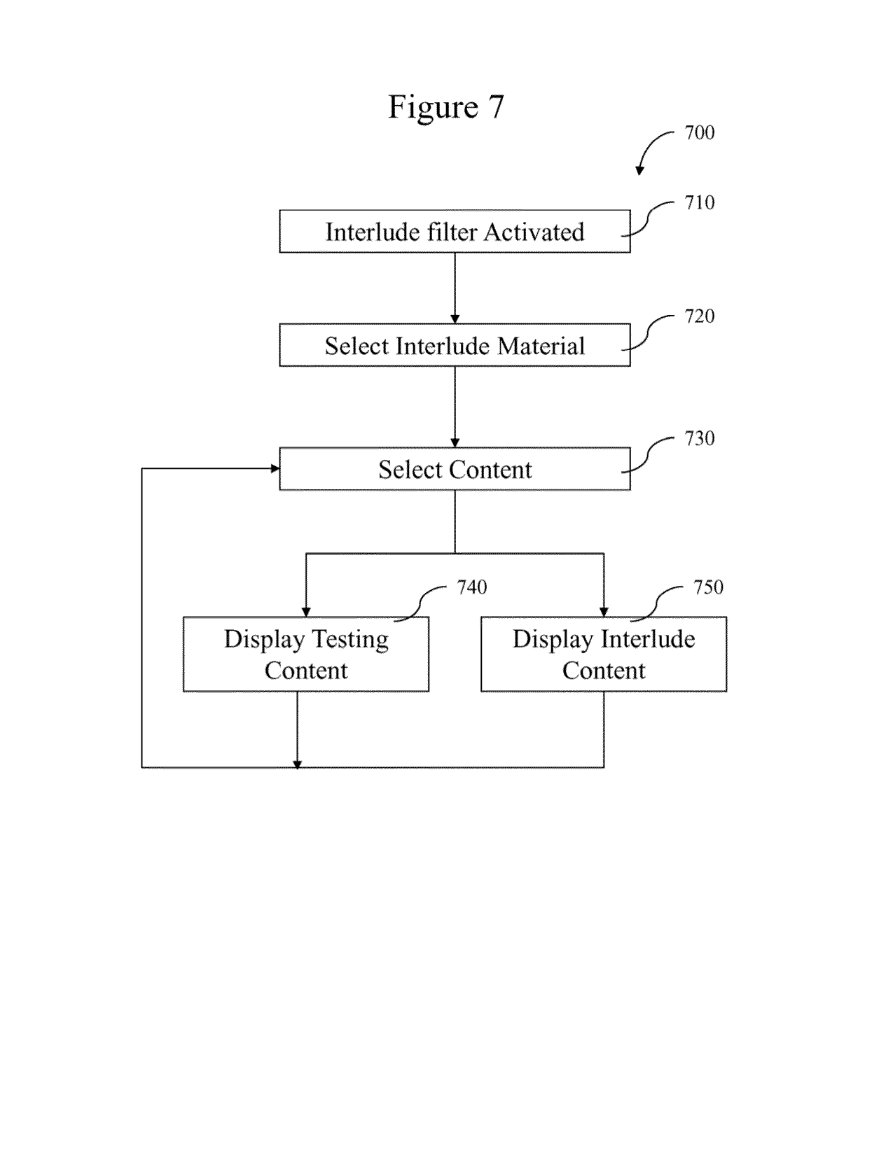

For example, referring to FIG. 7, the interlude filter 700 may be activated (710) and interlude material may be selected (720). The interlude filter 700 may then select which content to display (730). The content selection (730) may be done according to any suitable criteria. For example, the content selection (730) may be randomly or semi-randomly pick a content to display. The content selection (730) may also choose to display the training content for a predetermined number of case studies or it could use a combination of random and preset thresholds to determine which content to select. If the interlude filter 700 determines to display the regular testing content, the testing content is displayed (740). If the interlude filter 700 determines to display the interlude content, the interlude content is displayed (750). By injecting an interesting content, the user will be encouraged to keep working in order to receive more of the interesting content, increasing overall participation and repetition.

One or more filters may be active at any given time and may be activated by either the administrator or the user. For example, the administrator [?] may activate the timer filter and allow for the user to activate any of the other filters. If the user elects to not activate additional filters, training takes place using only the timer filter. If the user elects to activate more filters, such as the bullsh*t filter, the icons filter, and/or the interlude filter, then all of the features of the activated filters are activated. Thus, the bullsh*t button and rules become activated, the explanation window 420 includes the icons 500, and interlude content is added to the testing content, thus altering the format of the apply section 120.

In the foregoing specification, the invention has been described with reference to specific exemplary embodiments. Various modifications and changes may be made without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any appropriate order and are not limited to the specific order presented in the claims. Additionally, the components and/or elements recited in any apparatus claims may be assembled or otherwise operationally configured in a variety of permutations and are accordingly not limited to the specific configuration recited in the specification and shown in the drawings.

Benefits, advantages, and solutions to problems have been described above with regard to particular embodiments. Any benefit, advantage, solution to problem or any element that may cause any particular benefit, advantage or solution to occur or to become more pronounced are not to be construed as critical, required or essential features or components of any or all the claims.

As used in this description, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the invention.

1. A computer-implemented method of training a user, comprising:
retrieving a training content from a memory; and
administering the training content according to the user in conjunction with at least one configuration option, wherein the configuration option is substantially optimized to at least one of:
increase the user's training participation; and
increase the user's training content retention.

2. The computer-implemented method of training a user of claim 1, wherein the configuration option comprises:
providing the user with an incorrect explanation when a correct answer is given by the user; and
requiring the user to recognize the incorrect explanation in order to receive a correct score.

3. The computer-implemented method of training a user of claim 2, wherein providing the user with the incorrect explanation when the correct answer is given by the user comprises randomly providing the user with an incorrect explanation when the correct answer is give by the user.

4. The computer-implemented method of training a user of claim 1, wherein the configuration option comprises displaying at least one icon, wherein the icon is configured to convey a concept related to the training content.

5. The computer-implemented method of training a user of claim 4, wherein the at least one icon comprises at least one of:
a picture;
a sound; and
an animation.

6. The computer-implemented method of training a user of claim 1, wherein the configuration option comprises providing the user with an interlude content.

7. The computer-implemented method of training a user of claim 1, wherein the configuration option comprises:
presenting the user with a positive sound when the user inputs a correct answer; and
presenting the user with a negative sound when the user inputs an incorrect answer.

8. The computer-implemented method of training a user of claim 1, wherein the configuration option may be selected by at least one of a test taker and a test administrator, and wherein the configuration option is automatically implemented upon selection.

9. A computer-implemented method of training a user, comprising:
retrieving a training content from a memory; and
administering the training content according to the user in conjunction with at least one configuration option, wherein the configuration comprises at least one of:
alter the presentation of a content by representing the content as at least one icon;
provide the user with an incorrect explanation when a correct answer is given by the user; and
present a mood enhancing stimulus to the user.

10. The computer-implemented method of training a user of claim 9, wherein provide the user with an incorrect explanation when a correct answer is given by the user comprises:
providing the user with an incorrect explanation when a correct answer is given by the user; and
requiring the user to recognize the incorrect explanation in order to receive a correct score.

11. The computer-implemented method of training a user of claim 10, wherein providing the user with the incorrect explanation when the correct answer is given by the user comprises randomly providing the user with an incorrect explanation when the correct answer is give by the user.

12. The computer-implemented method of training a user of claim 9, wherein the icon is configured to convey a concept related to the training content.

13. The computer-implemented method of training a user of claim 9, wherein the at least one icon comprises at least one of:
a picture;
a sound; and
an animation.

14. The computer-implemented method of training a user of claim 9, wherein the configuration option comprises providing the user with an interlude content.

15. The computer-implemented method of training a user of claim 9, wherein the configuration option comprises:
presenting the user with a positive sound when the user inputs a correct answer; and
presenting the user with a negative sound when the user inputs an incorrect answer.

16. The computer-implemented method of training a user of claim 9, wherein the configuration option may be selected by at least one of a test taker and a test administrator, and wherein the configuration option is automatically implemented upon selection.

17. A computer system, comprising:
a processor; and
a memory responsive to the processor, wherein the memory stores a testing program configured to cause the processor to:
retrieve training content; and
administer the training content according to a user in conjunction with at least one configuration option, wherein the configuration option is substantially optimized to at least one of:
increase the user's training participation; and,
increase the user's training content retention.

18. The computer system of claim 17, wherein the configuration option comprises:
providing the user with an incorrect explanation when a correct answer is given by the user; and
requiring the user to recognize the incorrect explanation in order to receive a correct score.

19. The computer system of claim 18, wherein providing the user with the incorrect explanation when the correct answer is given by the user comprises randomly providing the user with an incorrect explanation when the correct answer is give by the user.

20. The computer system of claim 17, wherein the configuration option comprises displaying at least one icon, wherein the icon is configured to convey a concept related to the training content.

21. The computer system of claim 20, wherein the at least one icon comprises at least one of:
a picture;
a sound; and
an animation.

22. The computer system of claim 17, wherein the configuration option comprises providing the user with an interlude content.

23. The computer system of claim 17, wherein the configuration option comprises:
presenting the user with a positive sound when the user inputs a correct answer; and
presenting the user with a negative sound when the user inputs an incorrect answer.

24. The computer system of claim 17, wherein the configuration option may be selected by at least one of a test taker and a test administrator, and wherein the configuration option is automatically implemented upon selection.

25. A non-transitory computer-readable medium storing computer-executable instructions for training a user, wherein the instructions are configured to cause a computer to:
retrieve a training content from a memory; and
administer the training content according to the user in conjunction with at least one configuration option, wherein the configuration option is substantially optimized to at least one of:
increase the user's training participation; and
increase the user's training content retention.

26. The non-transitory computer-readable medium storing computer-executable instructions for training a user of claim 25, wherein the configuration option comprises:
providing the user with an incorrect explanation when a correct answer is given by the user; and
requiring the user to recognize the incorrect explanation in order to receive a correct score.

27. The non-transitory computer-readable medium storing computer-executable instructions for training a user of claim 26, wherein providing the user with the incorrect explanation when the correct answer is given by the user comprises randomly providing the user with an incorrect explanation when the correct answer is give by the user.

28. The non-transitory computer-readable medium storing computer-executable instructions for training a user of claim 25, wherein the configuration option comprises displaying at least one icon, wherein the icon is configured to convey a concept related to the training content.

29. The non-transitory computer-readable medium storing computer-executable instructions for training a user of claim 28, wherein the at least one icon comprises at least one of:
a picture;
a sound; and
an animation.

30. The non-transitory computer-readable medium storing computer-executable instructions for training a user of claim 25, wherein the configuration option comprises providing the user with an interlude content.

31. The non-transitory computer-readable medium storing computer-executable instructions for training a user of claim 25, wherein the configuration option comprises:
presenting the user with a positive sound when the user inputs a correct answer; and
presenting the user with a negative sound when the user inputs an incorrect answer.

32. The non-transitory computer-readable medium storing computer-executable instructions for training a user of claim 25, wherein the configuration option may be selected by at least one of a test taker and a test administrator, and wherein the configuration option is automatically implemented upon selection.
